(19) United States
(12) Patent Application Publication
(10) Pub. No.: US 2026/0259447 A1
(43) Pub. Date: Sep. 3, 2026

(54) Dimming Panel and Display Device

(71) Applicants: BOE TECHNOLOGY GROUP CO., LTD., Chaoyang District, Beijing (CN); HEFEI BOE OPTOELECTRONICS TECHNOLOGY CO., LTD., Hefei, Anhui (CN)

(72) Inventors: Shaoxun Qin, Beijing (CN); Dong Wang, Beijing (CN); Fengjing Tang, Beijing (CN); Hongmin Li, Beijing (CN); Silin Feng, Beijing (CN); Xiuchen Shao, Beijing (CN)

(21) Appl. No.: 18/994,742

(22) PCT Filed: May 16, 2024
(86) PCT No.: PCT/CN2024/093763

§ 371 Date: Jan. 15, 2025

(30) Foreign Application Priority Data
Jun. 7, 2023 (CN) 202310672183.0

(51) Int. Cl. G02F 1/1333; G02F 1/1335; G02F 1/1339; G02F 1/1343

(52) U.S. Cl. CPC G02F 1/133368; G02F 1/133512; G02F 1/133531; G02F 1/1339; G02F 1/13439

(57) ABSTRACT

A dimming panel has a display region and a peripheral region, and the dimming panel includes a first substrate and a second substrate that are arranged oppositely, a frame sealant, a first liquid crystal layer, a functional electrode layer, a conductive layer, a common electrode layer. The functional electrode layer includes a control electrode in the peripheral region and a driving electrode in the display region, and the control electrode is located on a side of the frame sealant proximate to the display region, and surrounds at least a portion of the display region. The conductive laver is disposed between the first substrate and the functional electrode layer. The conductive layer includes a control signal line and a driving signal line, and the control signal line includes a first control signal line and a second control signal line. The driving signal line is electrically connected to the driving electrode.

### CROSS-REFERENCE TO RELATED APPLICATIONS

This application is the United States national phase of International Patent Application No. PCT/CN2024/093763, filed May 16, 2024, and claims priority to Chinese Patent Application No. 202310672183.0, filed Jun. 7, 2023, the disclosures of which are hereby incorporated by reference in entireties.

### BACKGROUND OF THE INVENTION

### Field of the Invention

The present disclosure relates to the field of display technologies, and in particular, to a dimming panel and a display device.

### Description of Related Art

In the field of liquid crystal display, a dimming panel design has appeared in the display device. In the display device, a dimming panel is arranged between a backlight module and a display panel, and the dimming panel controls an amount of light emitted from the backlight module and transmitted through the dimming panel to control the backlight directing to the display panel, thereby achieving the purpose of privacy or regional control of the backlight of the display device.

For example, the dimming panel in the display device can control an emission angle range of the backlight provided by the backlight module, thereby achieving the privacy state or the shared display state of the display device.

For another example, the dimming panel in the display device can perform the regional control of the backlight to achieve the high contrast display of the display device, thereby achieving the high dynamic range imaging (HDR) technology of the display device.

### SUMMARY OF THE INVENTION

In an aspect, a dimming panel is provided. The dimming panel has a display region and a peripheral region surrounding the display region. The dimming panel includes a first substrate and a second substrate that are arranged oppositely, a frame sealant, a first liquid crystal layer, a functional electrode layer, a conductive layer, and a common electrode layer. The first substrate is opposite to the second substrate. The frame sealant connects the first substrate and the second substrate, and the frame sealant is located in the peripheral region and surrounds the display region. The first liquid crystal layer is disposed in a cavity enclosed by the first substrate, the frame sealant and the second substrate. The functional electrode layer is disposed on a side of the first substrate proximate to the first liquid crystal layer, and the functional electrode layer includes a control electrode located in the peripheral region and a driving electrode located in the display region. The control electrode is located on a side of the frame sealant proximate to the display region, and surrounds at least a portion of the display region. The conductive layer is disposed between the first substrate and the functional electrode layer, and the conductive layer includes a control signal line and at least one driving signal line. The control signal line includes a first control signal line and a second control signal line that are connected to each other. The first control signal line is located on the side of the frame sealant proximate to the display region, and the second control signal line is located on a side of the frame sealant away from the display region. The first control signal line is electrically connected to the control electrode. A portion of a driving signal line is located in the display region, and the driving signal line is electrically connected to the driving electrode. The common electrode layer is disposed between the conductive layer and the functional electrode layer or disposed on a side of the second substrate proximate to the first liquid crystal layer. There is a voltage difference between a control voltage transmitted to the control electrode from the first control signal line and a common voltage transmitted in the common electrode layer.

An orthographic projection of the first control signal line on the first substrate is located between an orthographic projection of the frame sealant on the first substrate and an orthographic projection of the display region on the first substrate, and the orthographic projection of the first control signal line on the first substrate at least partially overlaps with an orthographic projection of the control electrode on the first substrate; and/or a wiring shape of the first control signal line is the same as that of the control electrode.

In some embodiments, the peripheral region includes a first bonding region. The dimming panel further includes at least one target pin located in the first bonding region, and the second control signal line is electrically connected to a target pin in the at least one target pin.

In some embodiments, an access end of the second control signal line is spaced apart from the first bonding region. The conductive layer further includes a connection line, a first end of the connection line is bonded to the target pin, and a second end of the connection line and the access end of the second control signal line constitute a one-piece structure. Alternatively, the conductive layer further includes a connection line, a first end of the connection line is bonded to the target pin, and a second end of the connection line is spaced apart from the access end of the second control signal line; and the functional electrode layer further includes a bridge pattern located on the second end of the connection line and the access end of the second control signal line, and the second end of the connection line is electrically connected to the access end of the second control signal line through the bridge pattern.

In some embodiments, the access end of the second control signal line is arranged opposite to a region occupied by the target pin.

In some embodiments, the control electrode includes a first sub-line, a second sub-line, a third sub-line and a fourth sub-line that are connected end to end in sequence. The first sub-line is located on a side of the display region proximate to the first bonding region, and the first sub-line and the fourth sub-line are disconnected from each other to form an opening. The opening is arranged opposite to the first bonding region.

In some embodiments, the first control signal line is in a shape of a ring with an opening; and the second control signal line has two access ends, and each of the two access ends is electrically connected to a target pin.

In some embodiments, at least a portion of the first control signal line is in a shape of a grid, and/or at least a portion of the second control signal line is in a shape of a grid.

In some embodiments, a minimum distance between an orthographic projection of the control electrode on the first substrate and an orthographic projection of the frame sealant on the first substrate is greater than or equal to 0.2 mm.

In some embodiments, the functional electrode layer further includes a transfer electrode located in the peripheral region, and the transfer electrode is disposed on a surface of the frame sealant proximate to the first substrate. The conductive layer further includes a common voltage signal line located in the peripheral region. In a case where the common electrode layer is located between the conductive layer and the functional electrode layer, the transfer electrode is electrically connected to the common electrode layer, and the transfer electrode is further electrically connected to the common voltage signal line. In a case where the common electrode layer is located on a side of the second substrate proximate to the first liquid crystal layer, the common electrode layer is in contact with the frame sealant, and the frame sealant has conductive particles; and the transfer electrode is electrically connected to the common voltage signal line.

In some embodiments, a distance between an orthographic projection of the transfer electrode on the first substrate and an orthographic projection of the control electrode on the first substrate is less than or equal to 0.05 mm.

In some embodiments, an orthographic projection of the transfer electrode on the first substrate at least partially overlaps with an orthographic projection of the frame sealant on the first substrate.

In some embodiments, a minimum distance between an orthographic projection of the driving electrode on the first substrate and an orthographic projection of the control electrode on the first substrate is greater than or equal to 0.13 mm.

In some embodiments, the driving signal line is polyline-shaped.

In some embodiments, in a case where the common electrode layer is located between the conductive layer and the functional electrode layer, the driving electrode includes a plurality of driving electrode blocks, and the plurality of driving electrode blocks are arranged in multiple rows and multiple columns. The at least one driving signal line includes a plurality of driving signal sub-lines, and the plurality of driving signal sub-lines extend in a column direction and are sequentially arranged at intervals in a row direction. The common electrode layer has a plurality of via holes, and a driving electrode block in the plurality of driving electrode blocks passes through a corresponding via hole in the plurality of via holes to be electrically connected to a driving signal sub-line in the plurality of driving signal sub-lines.

In some embodiments, the conductive layer further includes a plurality of transmission signal lines located in the display region, and the plurality of transmission signal lines extend in the column direction and are sequentially arranged at intervals in the row direction. A column of driving electrode blocks corresponds to at least one transmission signal line in the plurality of transmission signal lines.

In some embodiments, the conductive layer further includes a plurality of light-shielding lines located in the display region, and the plurality of light-shielding lines extend in the row direction and are sequentially arranged at intervals in the column direction. An orthographic projection of a light-shielding line in the plurality of light-shielding lines on the first substrate is located between orthographic projections of two adjacent rows of driving electrode blocks on the first substrate.

In some embodiments, in the column direction, a dimension of the orthographic projection of the light-shielding line on the first substrate is greater than or equal to a dimension of a gap between the orthographic projections of two adjacent rows of driving electrode blocks on the first substrate.

In some embodiments, the light-shielding line is disconnected at an intersection between the light-shielding line and the driving signal sub-line.

In another aspect, a display device is provided. The display device includes a backlight module, the dimming panel as described in any one of the above embodiments, and a display panel disposed on a side of the dimming panel away from the backlight module.

In some embodiments, the peripheral region includes a first bonding region; and the dimming panel further includes at least one target pin located in the first bonding region, and the second control signal line is electrically connected to a target pin in the at least one target pin. The display device further includes a flexible circuit board bonded to the target pin in the first bonding region of the dimming panel.

In some embodiments, in the dimming panel, the driving electrode in the functional electrode layer includes a plurality of driving electrode blocks, and the at least one driving signal line includes a plurality of driving signal sub-lines. The peripheral region of the dimming panel further includes a second bonding region, and the second bonding region is located between the first bonding region and the frame sealant of the dimming panel. The plurality of driving signal sub-lines extend out of a region defined by the frame sealant and extend to the second bonding region. The display device further includes a driving chip bonded to the second bonding region, and the driving chip is electrically connected to the plurality of driving signal sub-lines.

In some embodiments, the display device further includes a first polarizer, a second polarizer and a third polarizer. The first polarizer is disposed between the backlight module and the dimming panel. The second polarizer is disposed between the dimming panel and the display panel, and a transmission axis of the second polarizer is parallel to a transmission axis of the first polarizer. The third polarizer is disposed on the display panel, and a transmission axis of the third polarizer is perpendicular to the transmission axis of the first polarizer.

In some embodiments, the display device further includes a privacy film, a fourth polarizer and a fifth polarizer. The privacy film is disposed between the backlight module and the dimming panel. The fourth polarizer is disposed between the dimming panel and the display panel. The fifth polarizer is disposed on the display panel.

### BRIEF DESCRIPTION OF THE DRAWINGS

In order to describe technical solutions in the present disclosure more clearly, the accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings. In addition, the accompanying drawings to be described below may be regarded as schematic diagrams, and are not limitations on actual sizes of products involved in the embodiments of the present disclosure.

FIG. 1 is a structural diagram of a display device, in accordance with some embodiments of the present disclosure;

FIG. 2 is a structural diagram of another display device, in accordance with some embodiments of the present disclosure;

FIG. 3 is a sectional view taken along the CC′ line in FIG. 1;

FIG. 4 is another sectional view taken along the CC′ line in FIG. 1;

FIG. 5A is a structural diagram of a dimming panel, in accordance with some embodiments of the present disclosure;

FIG. 5B is a structural diagram of another dimming panel, in accordance with some embodiments of the present disclosure;

FIG. 5C is a structural diagram of a control electrode in FIG. 5B;

FIG. 5D is a structural diagram of a control signal line in FIG. 5B;

FIG. 6 is a sectional view taken along the DD′ line in FIG. 5A;

FIG. 7 is a sectional view taken along the EE′ line in FIG. 5B;

FIG. 8 is a partial structural diagram of a dimming panel, in accordance with some embodiments of the present disclosure;

FIG. 9 is a partial structural diagram of another dimming panel, in accordance with some embodiments of the present disclosure;

FIG. 10A is a structural diagram of yet another display device, in accordance with some embodiments of the present disclosure;

FIG. 10B is a partial enlarged view of the region Q1 in FIG. 10A;

FIG. 10C is a partial enlarged view of the region Q2 in FIG. 10B;

FIG. 10D is another partial enlarged view of the region Q2 in FIG. 10B;

FIG. 10E is a sectional view taken along the FF′ line in FIG. 10D;

FIG. 11 is a partial enlarged view of the region Q3 in FIG. 10A;

FIG. 12 is a partial enlarged view of the region Q4 in FIG. 11;

FIG. 13A is a structural diagram of yet another display device, in accordance with some embodiments of the present disclosure;

FIG. 13B is a structural diagram of yet another display device, in accordance with some embodiments of the present disclosure;

FIG. 14 is a sectional view taken along the GG′ line in FIG. 13B;

FIG. 15 is a partial enlarged view of the region Q5 in FIG. 13A;

FIG. 16 is a partial enlarged view of the region Q6 in FIG. 15;

FIG. 17 is a partial enlarged view of the region Q7 in FIG. 13B;

FIG. 18 is a partial enlarged view of the region Q8 in FIG. 10A;

FIG. 19 is a partial enlarged view of the region Q9 in FIG. 18;

FIG. 20 is a structural diagram of yet another display device, in accordance with some embodiments of the present disclosure;

FIG. 21A is a diagram showing a light propagation path of a display device, in accordance with some embodiments of the present disclosure;

FIG. 21B is a diagram showing another light propagation path of a display device, in accordance with some embodiments of the present disclosure;

FIG. 22 is a structural diagram of yet another display device, in accordance with some embodiments of the present disclosure;

FIG. 23 is a sectional view taken along the NN′ line in FIG. 22;

FIG. 24 is a sectional view taken along the OO′ line in FIG. 22; and

FIG. 25 is a structural diagram of yet another display device, in accordance with some embodiments of the present disclosure.

### DESCRIPTION OF THE INVENTION

The technical solutions in some embodiments of the present disclosure will be described clearly and completely with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a plurality of”, “the plurality of” and “multiple” each mean two or more unless otherwise specified.

In the description of some embodiments, the terms such as “coupled” and “connected” and derivatives thereof may be used. The term “connected” should be understood in a broad sense. For example, the term “connected” may represent a fixed connection, or a detachable connection, or a one-piece connection; alternatively, the term “connected” may represent a direct connection, or an indirect connection through an intermediate medium. The term “coupled”, for example, indicates that two or more components are in direct physical or electrical contact. The term “coupled” or “communicatively coupled” may also indicate that two or more components are not in direct contact with each other, but still cooperate or interact with each other. The embodiments disclosed herein are not necessarily limited to the context herein.

The phrase “applicable to” or “configured to” as used herein indicates an open and inclusive expression, which does not exclude devices that are applicable to or configured to perform additional tasks or steps.

In addition, the phrase “based on” as used herein is meant to be open and inclusive, since a process, step, calculation or other action that is “based on” one or more of the stated conditions or values may, in practice, be based on additional conditions or values beyond those stated.

As used herein, the term such as “about”, “substantially” or “approximately” includes a stated value and an average value within an acceptable range of deviation of a particular value. The acceptable range of deviation is determined by a person of ordinary skill in the art in view of measurement in question and errors associated with the measurement of a particular quantity (i.e., the limitation of the measurement system).

As used herein, the term such as “parallel”, “perpendicular”, or “equal” includes a stated condition and a condition similar to the stated condition. A range of the similar condition is in an acceptable range of deviation, and the acceptable range of deviation is determined by a person of ordinary skill in the art in view of measurement in question and errors associated with the measurement of a particular quantity (i.e., the limitation of the measurement system). For example, the term “parallel” includes absolute parallelism and approximate parallelism, and an acceptable range of deviation of the approximate parallelism may be, for example, a deviation within 5°. The term “perpendicular” includes absolute perpendicularity and approximate perpendicularity, and an acceptable range of deviation of the approximate perpendicularity may also be, for example, a deviation within 5°. The term “equal” includes absolute equality and approximate equality, and an acceptable range of deviation of the approximate equality may be, for example, a difference between two equals being less than or equal to 5% of any one of the two equals.

The phrase “A and/or B” includes the following three combinations: only A, only B, and a combination of A and B.

It should be understood that, in a case where a layer or element is referred to be on another layer or substrate, it may be that the layer or element is directly on the another layer or substrate, or it may be that intervening layer(s) exist between the layer or element and the another layer or substrate.

Exemplary embodiments are described herein with reference to sectional views and/or plan views as idealized exemplary drawings. In the drawings, thicknesses of layers and sizes of regions are enlarged for clarity. Variations in shapes relative to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a feature of being curved. Therefore, the regions shown in the accompanying drawings are schematic in nature, and their shapes are not intended to show actual shapes of regions in devices, and are not intended to limit the scope of the exemplary embodiments.

Some embodiments of the present disclosure provide a dimming panel and a display device, and the dimming panel and the display device are respectively described below with reference to the accompanying drawings.

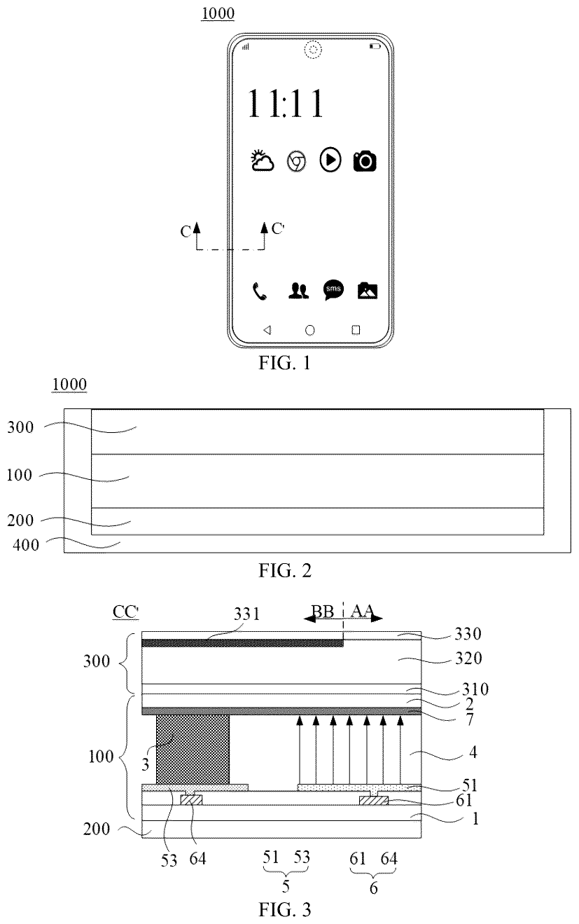

As shown in FIG. 1, some embodiments of the present disclosure provide a display device 1000. The display device 1000 may be any device that displays images whether in motion (e.g., videos) or stationary (e.g., static images), and whether textual or graphical. More specifically, it is expected that the embodiments may be implemented in or associated with a variety of electronic devices. The variety of electronic devices may include (but are not limited to), for example, mobile phones, wireless devices, personal digital assistants (PDAs), hand-held or portable computers, global positioning system (GPS) receivers/navigators, cameras, MP4 video players, video cameras, game consoles, television monitors, flat panel displays, computer monitors, car displays (such as odometer displays), navigators, cockpit controllers and/or displays, etc.

In some examples, as shown in FIG. 2, the display device 1000 includes a backlight module 200, a dimming panel 100, a display panel 300, and a housing 400. The dimming panel 100 is disposed on a light-exit side of the backlight module 200, and the display panel 300 is disposed on a side of the dimming panel 100 away from the backlight module 200. The backlight module 200, the dimming panel 100, and the display panel 300 are disposed in the housing 400. The housing 400 has a certain strength and can provide protection for the backlight module 200, the dimming panel 100, and the display panel 300 that are disposed in the housing 400. For example, a material of the housing includes plastic.

Here, the backlight module 200 may be used for providing backlight. For example, the light-exit side of the backlight module refers to a side where the backlight module emits light.

The dimming panel 100 is used to adjust light passing through itself. The display panel is used to cooperate with the backlight module and the dimming panel to achieve image display. By using the dimming panel to adjust the light passing through itself, the display device 1000 can have a privacy function, or can enable the display device 1000 to have a high contrast display function.

For example, the display panel 300 is a liquid crystal display panel. Depending on a different display mode, the display panel 300 may be a twisted nematic (TN) display panel, an in-plane switching (IPS) display panel, or an advanced super dimension switch (ADS) display panel, which may be selected according to actual needs, and the present disclosure does not limit this.

For example, the display panel 300 is driven in a passive matrix (PM) driving mode or an active matrix (AM) driving mode. In a case where the display panel 300 is driven in the AM driving mode, the display panel 300 is, for example, a thin film transistor liquid crystal display (TFT-LCD) panel.

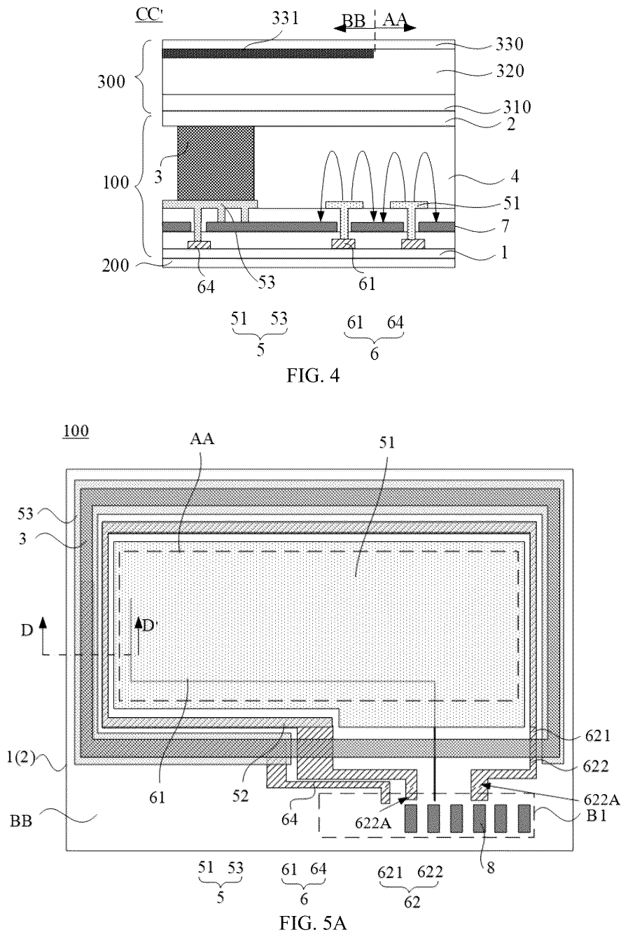

In some examples, as shown in FIGS. 3 and 4, in a direction perpendicular to and away from the backlight module 200, the display panel 300 includes an array substrate 310, a second liquid crystal layer 320, and a color filter substrate 330 that are stacked in sequence.

For example, the array substrate 310 includes a plurality of thin film transistors and a plurality of pixel electrodes electrically connected to the plurality of thin film transistors. Each thin film transistor can provide an electrical signal for a corresponding pixel electrode.

For example, the color filter substrate 330 includes a variety of color filters. For example, in a case where light incident on the color filters is white light, the color filters include red filters, green filters, and blue filters. The red filter may transmit only red light of the incident light, the green filter may transmit only green light of the incident light, and the blue filter may transmit only blue light of the incident light. For example, in a case where light incident on the color filters is blue light, the color filters include red filters and green filters.

As shown in FIGS. 3 and 4, the color filter substrate 330 further includes a black matrix 331.

For example, the black matrix 331 is disposed between adjacent color filters to isolate color filters of different colors, avoiding light mixing.

For example, the black matrix 331 is also disposed in a region adjacent to a display region AA and a peripheral region BB to prevent oblique light of the peripheral region BB from exiting from the display region AA, thereby avoiding light leakage of the display region AA.

The display panel further includes a common electrode, and the common electrode can be disposed in the array substrate or in the color filter substrate. The common electrode is used to receive a common voltage signal.

For example, there is a voltage difference between the common voltage signal and the electrical signal in the pixel electrode, so that an electric field can be generated between the common electrode and the pixel electrode. Liquid crystal molecules in the second liquid crystal layer can deflect under the action of the electric field, so that the amount of light passing through the liquid crystal molecules is changed, and the light exiting through the liquid crystal molecules reaches a preset brightness. The light exits after passing through the color filters of different colors in the color filter substrate. The exit light includes light of various colors such as red light, green light and blue light, and the light of various colors cooperates with each other to enable the display device to perform display.

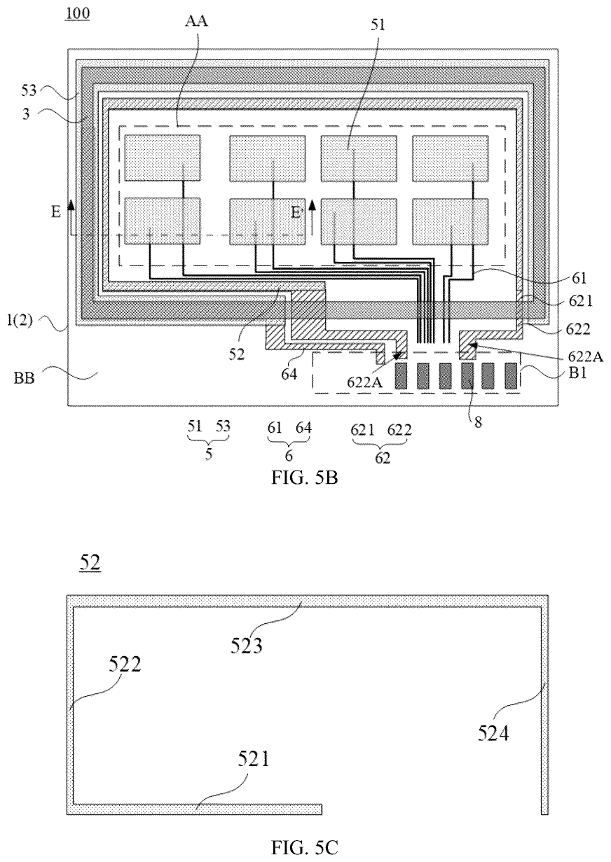

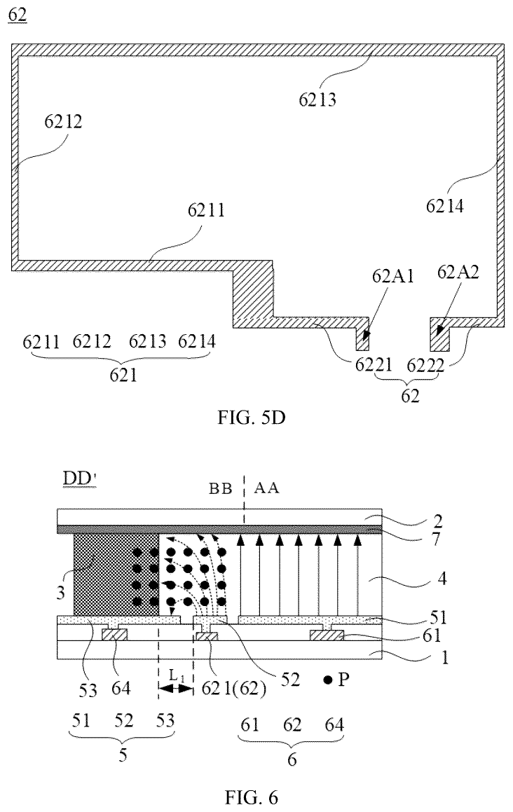

In some embodiments, as shown in FIGS. 5A and 5B, the dimming panel 100 has a display region AA and a peripheral region BB surrounding the display region AA. The display region AA corresponds to a region of the display panel 300 for displaying images; the peripheral region BB is a region of the dimming panel 100 other than the display region AA, and the peripheral region BB surrounds the display region AA.

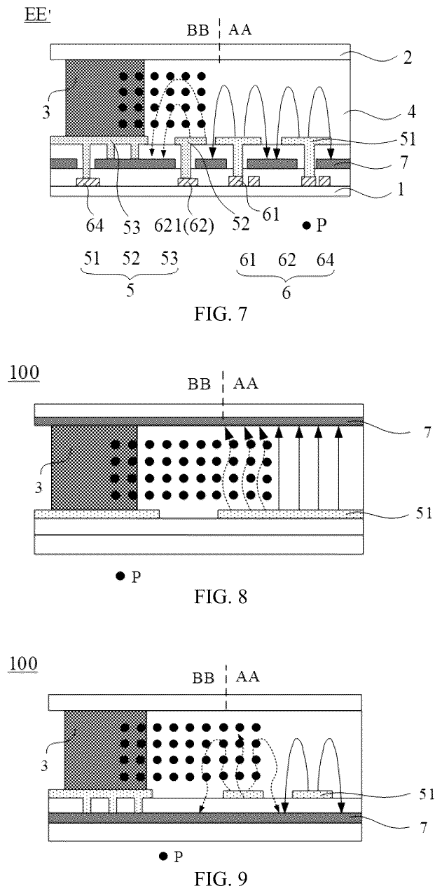

In some examples, as shown in FIGS. 6 and 7, the dimming panel 100 includes a first substrate 1, a second substrate 2, a frame sealant 3, a first liquid crystal layer 4, a functional electrode layer 5, a conductive layer 6 and a common electrode layer 7.

The first substrate 1 is arranged opposite to the second substrate 2. Materials of the first substrate 1 and the second substrate 2 can be same or different. The materials of the first substrate 1 and the second substrate 2 can include an organic material or an inorganic material.

For example, the first substrate 1 and the second substrate 2 are both glass substrates.

The frame sealant 3 connects the first substrate 1 and the second substrate 2. As shown in FIGS. 5A and 5B, the frame sealant 3 is located in the peripheral region BB and surrounds the display region AA. The frame sealant 3 is not only used to support the first substrate 1 and the second substrate 2, but also used to form a closed cavity together with the first substrate 1 and the second substrate 2 to provide a containing space for the first liquid crystal layer 4. The first liquid crystal layer 4 is disposed in the cavity enclosed by the first substrate 1, the frame sealant 3 and the second substrate 2.

The closed cavity may also isolate the air to prevent the first liquid crystal layer 4 in the cavity from being contaminated.

For example, a material of the frame sealant 3 includes an organic material.

As shown in FIGS. 6 and 7, the functional electrode layer 5 is disposed on a side of the first substrate 1 proximate to the first liquid crystal layer 4. The functional electrode layer 5 includes a driving electrode 51 located in the display region AA.

The arrangement of the driving electrode 51 may vary, which may be set according to actual needs.

For example, as shown in FIG. 5A, the driving electrode 51 is of a one-piece structure. That is, only one driving electrode 51 is disposed in the display region AA.

For another example, as shown in FIG. 5B, the driving electrode 51 is divided into a plurality of patterns. That is, the driving electrode 51 includes a plurality of driving electrode blocks that are independent of each other.

For example, a material of the functional electrode layer 5 includes a transparent conductive material, which includes but is not limited to indium tin oxide. In this way, the driving electrode 51 located in the display region AA may have a relatively high transmittance, thereby avoiding blocking of light and avoiding affecting the display effect of the display device 1000.

As shown in FIGS. 6 and 7, the conductive layer 6 is disposed between the first substrate 1 and the functional electrode layer 5. The conductive layer 6 includes driving signal line(s) 61, and a portion of the driving signal line 61 is located in the display region AA. The driving signal line 61 is electrically connected to the driving electrode 51, and the driving signal line 61 is used to receive a driving signal required by the driving electrode 51 and transmit the driving signal to the driving electrode 51.

Materials of the functional electrode layer 5 and the conductive layer 6 may be the same or different. For example, the material of the functional electrode layer 5 is different from the material of the conductive layer 6; the material of the conductive layer 6 includes a metal material, and the metal material includes but is not limited to copper, gold, silver, or the like. In this way, it may be possible to reduce the attenuation of signals transmitted by signal lines (including but not limited to the driving signal line(s) 61) disposed in the conductive layer 6.

A location of the common electrode layer 7 is related to the display mode of the dimming panel 100, and can be specifically determined according to the display mode of the dimming panel 100.

In some examples, as shown in FIG. 7, the dimming panel 100 is in an advanced super dimension switch display mode. In this case, the common electrode layer 7 is disposed between the conductive layer 6 and the functional electrode layer 5.

Furthermore, as shown in FIG. 7, an insulating layer is provided between the common electrode layer 7 and the conductive layer 6, and an insulating layer is provided between the common electrode layer 7 and the functional electrode layer 5. The insulating layer between the common electrode layer 7 and the conductive layer 6, the common electrode layer 7, and the insulating layer between the common electrode layer 7 and the functional electrode layer 5 are provided with via holes therein, and the driving electrode 51 in the functional electrode layer 5 can be electrically connected to the driving signal line 61 in the conductive layer 6 through corresponding via holes.

In some other examples, as shown in FIG. 6, the dimming panel 100 is in a twisted nematic display mode. In this case, the common electrode layer 7 is disposed on a side of the second substrate 2 proximate to the first liquid crystal layer 4.

Furthermore, an insulating layer is provided between the functional electrode layer 5 and the conductive layer 6, and the insulating layer has via holes; and the driving electrode 51 can be electrically connected to the driving signal line 61 through a corresponding via hole without passing through the common electrode layer 7.

For example, a material of the common electrode layer 7 includes a transparent conductive material, which includes but is not limited to indium tin oxide. In this way, the common electrode layer 7 may have a relatively high transmittance, thereby avoiding blocking of part of light passing through the common electrode layer 7 and located in the display region AA, and avoiding affecting the display effect of the display device 1000.

The common electrode layer 7 can receive a common voltage signal, and the common voltage signal can be the same as or different from the common voltage signal received by the common electrode in the display panel 300. There is a voltage difference between the common voltage signal received by the common electrode layer 7 and the driving signal received by the driving electrode 51, so that an electric field can be formed between the common electrode layer 7 and the driving electrode 51. The electric field can drive the liquid crystal molecules in the first liquid crystal layer 4 to deflect, so as to adjust the polarization direction of the light passing through the dimming panel 100.

In an implementation, as shown in FIGS. 8 and 9, after the dimming panel 100 is manufactured, a reliability high temperature test needs to be performed on the dimming panel 100. After the test, the frame sealant 3 releases impurity ions P (such as silicon, oxygen, aluminum, titanium, boron, aromatic groups), and the impurity ions P may gradually diffuse into the first liquid crystal layer 4 and diffuse from the peripheral region BB to the display region AA of the dimming panel 100.

The impurity ions P generally have an electric charge. After the impurity ions diffuse into the display region AA, the impurity ions will affect the electric field formed by the common electrode layer and the driving electrode (as shown by the dotted arrows in FIGS. 8 and 9), which causes liquid crystal molecules in a region where the impurity ions are located to fail to deflect normally, and makes it difficult to control light in a portion of the display region AA close to the peripheral region BB, thereby causing light leakage in this part of the region (for example, manifested as a mountain-shaped display defect).

Currently, the influence of the impurity ions P on the liquid crystal molecules is usually reduced by reducing the content of the impurity ions P in the frame sealant 3. However, it is difficult to fundamentally remove the impurity ions in the frame sealant 3 using the current process, which means that the influence of the impurity ions P on the liquid crystal molecules is also difficult to eradicate.

In light of this, as shown in FIGS. 5A, 5B, 6 and 7, in the dimming panel 100 provided in the embodiments of the present disclosure, the functional electrode layer 5 further includes a control electrode 52 located in the peripheral region BB. The control electrode 52 is located on a side of the frame sealant 3 proximate to the display region AA, and surrounds at least a portion of the display region AA.

For example, the control electrode 52 is disposed on at least one side of the display region AA. Optionally, the display region AA is in a shape of a rectangle, and the control electrode 52 is disposed on one side of the display region AA. Alternatively, as shown in FIGS. 5A and 5B, the control electrode 52 is disposed on multiple sides of the display region AA.

As shown in FIGS. 5A and 5B, the conductive layer 6 further includes control signal line(s) 62. The control signal line 62 includes a first control signal line 621 and a second control signal line 622 that are connected to each other. The first control signal line 621 is located on a side of the frame sealant 3 proximate to the display region AA, and the second control signal line 622 is located on a side of the frame sealant 3 away from the display region AA. The first control signal line 621 is electrically connected to the control electrode 52.

For example, as shown in FIG. 6, in the case where the common electrode layer 7 is disposed on the side of the second substrate 2 proximate to the first liquid crystal layer 4, the control electrode 52 can be electrically connected to the first control signal line 621 through a corresponding via hole. In this case, the via hole penetrates through the insulating layer between the functional electrode layer 5 and the conductive layer 6.

For another example, as shown in FIG. 7, in the case where the common electrode layer 7 is disposed between the conductive layer 6 and the functional electrode layer 5, the control electrode 52 can be electrically connected to the first control signal line 621 through a corresponding via hole. It can be understood that, in this case, the via hole penetrates the insulating layers between the functional electrode layer 5 and the conductive layer 6, and the common electrode layer 7.

The second control signal line 622 is used to receive a control signal, and transmits the control signal to the first control signal line 621; and the control signal is finally transmitted to the control electrode 52. There is a voltage difference between a control voltage (i.e., a voltage of the control signal) transmitted to the control electrode 52 from the first control signal line 621 and the common voltage transmitted in the common electrode layer 7.

In this way, as shown in FIGS. 6 and 7, an electric field (also called a bound electric field, as shown by the dotted arrows in FIGS. 6 and 7) may be formed between the control electrode 52 and the common electrode layer 7, and the electric field is distributed in the peripheral region BB. The impurity ions P released from the frame sealant 3 are bound in the peripheral region BB due to the electric field during the process of diffusing from the peripheral region BB to the display region AA, which makes it difficult for the impurity ions to diffuse to the display region AA.

Based on this, in the dimming panel 100 provided in the embodiments of the present disclosure, the control electrode 52 is disposed in the functional conductive layer 5 and is located in the peripheral region BB, and the first control signal line 621 electrically connected to the control electrode 52 is disposed in the conductive layer 6, so that the first control signal line 621 may be used to transmit the control signal having a voltage difference with the common voltage signal to the control electrode 52, and the electric field may be formed between the control electrode 52 and the common electrode layer 7. In this way, when the impurity ions P in the frame sealant 3 are released and diffused to the first liquid crystal layer 4, the impurity ions P are bound in the peripheral region BB of the dimming panel 100 due to the electric field, which may prevent the impurity ions P from diffusing from the peripheral region BB to the display region AA, prevent the impurity ions P from affecting the electric field between the common electrode layer 7 and the driving electrode 51 in the display region AA, and avoid affecting the normal deflection of the liquid crystal molecules located between the common electrode layer 7 and the driving electrode 51. Thus, it is beneficial to alleviate the light leakage in a partial region of the display region AA proximate to the peripheral region BB. In a case where the conductive layer 6 is made of the metal material, the resistance of the control signal line 62 may be reduced, and the attenuation of the control voltage transmitted on the control signal line 62 may be reduced, which is beneficial to ensuring the stability of the electric field between the control electrode 52 and the common electrode layer 7, and ensuring the binding effect on the impurity ions P.

Moreover, in the embodiments of the present disclosure, instead of providing other additional film layers, by arranging the control electrode 52 in the functional electrode layer 5 and arranging the control signal line 62 in the conductive layer 6, it may avoid increasing the number of film layers in the dimming panel 100 and further avoid increasing the thickness of the dimming panel 100. In a case where the conductive layer 6 is made of the metal material, the resistance of the control signal line 62 may be reduced, and the attenuation of the control voltage transmitted on the control signal line 62 may be reduced, which is beneficial to ensuring the stability of the electric field between the control electrode 52 and the common electrode layer 7, and ensuring the bounded effect on the impurity ions P.

In some examples, in a direction perpendicular to an extension direction of the control electrode 52, a width of the control electrode 52 includes, but is not limited to, 0.12 mm.

It can be understood that, the larger the width of the control electrode 52 is, the larger the range of the electric field formed between the control electrode 52 and the common electrode layer 7 is, and the stronger the binding effect on the impurity ions P is. In the embodiments of the present disclosure, the width of the control electrode 52 can be adjusted according to the size of the dimming panel 100, thereby preventing the large width of the control electrode 52 from affecting the size of the peripheral region BB of the dimming panel 100 on the basis of a strong electric field existing between the control electrode 52 and the common electrode layer 7.

In some embodiments, as shown in FIGS. 5A and 5B, an orthographic projection of the first control signal line 621 on the first substrate 1 is located between an orthographic projection of the frame sealant 3 on the first substrate 1 and an orthographic projection of the display region AA on the first substrate 1, and the orthographic projection of the first control signal line 621 on the first substrate 1 at least partially overlaps with an orthographic projection of the control electrode 52 on the first substrate 1.

It should be noted that the “at least partially overlap” includes: partial overlap, full overlap, and coinciding.

With the above arrangement, a plurality of connection holes can be provided at the region where the orthographic projection of the first control signal line 621 on the first substrate 1 overlaps with the orthographic projection of the control electrode 52 on the first substrate 1 to achieve the electrical connection between the first control signal line 621 and the control electrode 52, which not only facilitates improving the reliability of the electrical connection between the first control signal line 621 and the control electrode 52, but also reduces the overall resistance of the overlapping part of the first control signal line 621 and the control electrode 52. Thus, it is beneficial to reduce the loss of the control voltage during the transmission on the overlapping part, and is beneficial to improve the stability of the electric field formed between the control electrode 52 and the common electrode layer 7, thereby ensuring the binding effect of the electric field on the impurity ions P.

Furthermore, an area occupied by the first control signal line 621 and the control electrode 52 in the entire dimming panel 100 may be reduced.

In some other embodiments, as shown in FIGS. 5A and 5B, a wiring shape of the first control signal line 621 is the same as that of the control electrode 52.

Here, the “wiring shape” refers to, for example, an extension direction of the wiring, a shape of the wiring, etc.

For example, the wiring shape of the first control signal line 621 is straight, and the wiring shape of the control electrode 52 is also straight.

Alternatively, the wiring shape of the first control signal line 621 is arc-shaped, and the wiring shape of the control electrode 52 is also arc-shaped.

Alternatively, as shown in FIG. 5B, the wiring shape of the first control signal line 621 is polyline-shaped, and the wiring shape of the control electrode 52 is also polyline-shaped. That is, as shown in FIG. 5C, the control electrode 52 includes a first sub-line 521, a second sub-line 522, a third sub-line 523 and a fourth sub-line 524 that are connected end to end in sequence; and in combination with FIG. 5B, the first sub-line 521 is located below the display region AA, the second sub-line 522 is located on the left side of the display region AA, the third sub-line 523 is located above the display region AA, and the fourth sub-line 524 is located on the right side of the display region AA. Correspondingly, as shown in FIG. 5D, the first control signal line 621 includes a fifth sub-line 6211, a sixth sub-line 6212, a seventh sub-line 6213 and an eighth sub-line 6214 that are connected end to end in sequence; and in combination with FIG. 5B, the fifth sub-line 6211 is located below the display region AA, the sixth sub-line 6212 is located on the left side of the display region AA, the seventh sub-line 6213 is located above the display region AA, and the eighth sub-line 6214 is located on the right side of the display region AA. The first sub-line 521 corresponds to the fifth sub-line 6211, the second sub-line 522 corresponds to the sixth sub-line 6212, the third sub-line 523 corresponds to the seventh sub-line 6213, and the fourth sub-line 524 corresponds to the eighth sub-line 6214.

With the above arrangement, positions where the control electrode 52 is arranged in the dimming panel 100 are all for arranging the control signal line 62 correspondingly. Therefore, in a direction toward the plane where the first substrate 1 is located, the portion of the control signal line 62 located on the side of the frame sealant 3 proximate to the display region AA may form a transmission channel for the control signal together with the control electrode 52, which is also beneficial to reducing the area occupied by the control signal line and the control electrode.

In some embodiments, as shown in FIGS. 5A and 5B, the peripheral region BB includes a first bonding region B1. The dimming panel 100 further includes at least one target pin 8 located in the first bonding region B1.

The number of target pins 8 can be one, two, three or even more. In a case where the number of target pins 8 is multiple, types of the multiple target pins 8 may be the same or different.

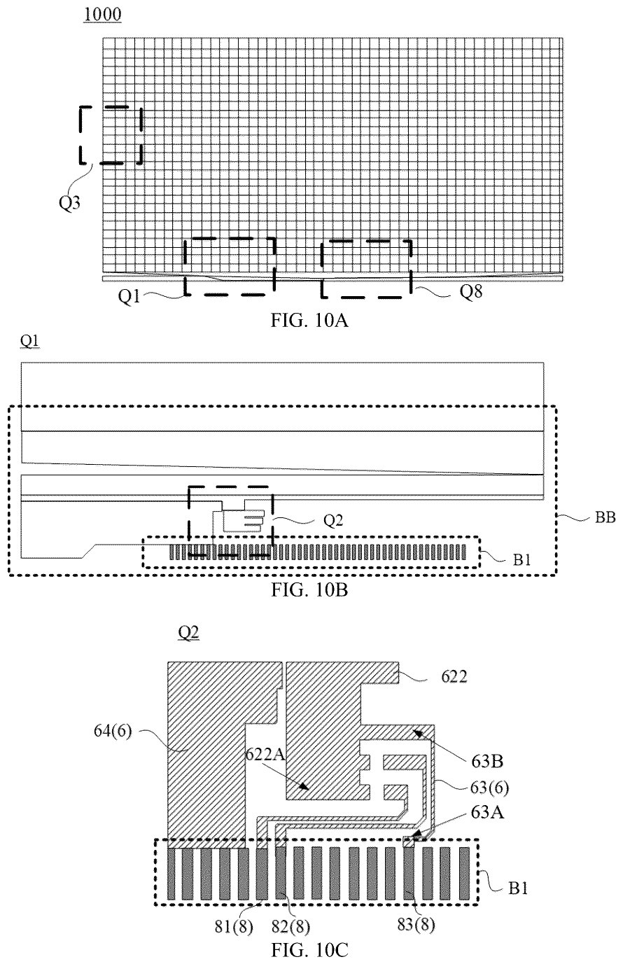

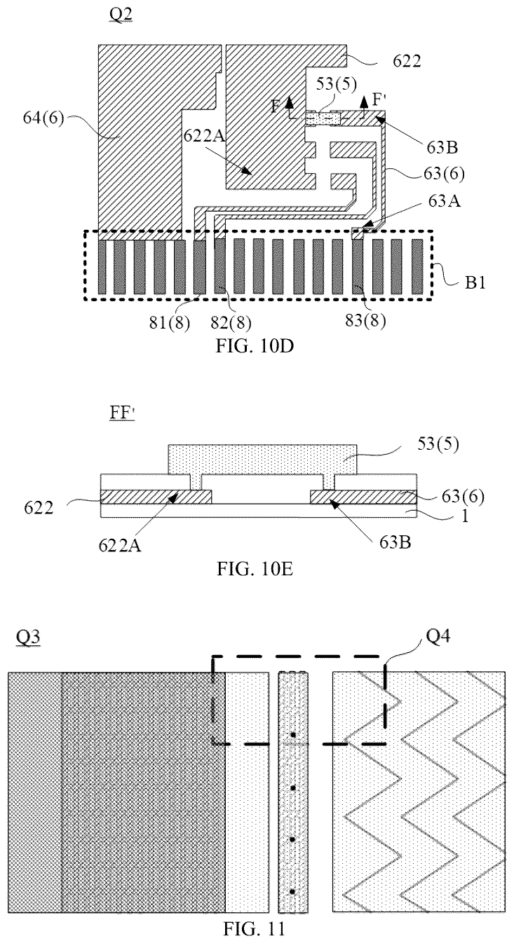

Optionally, there is one target pin 8. As shown in FIGS. 10A, 10B, and 10C, the target pin 8 can be a first voltage signal pin 81, a second voltage signal pin 82, or a clock signal pin 83. The first voltage signal pin 81 is used to transmit a first voltage signal. The first voltage signal is, for example, a high-level constant voltage signal. The second voltage signal pin 82 is used to transmit a second voltage signal. The second voltage signal is, for example, a low-level constant voltage signal. The clock signal pin 83 is used to transmit a clock signal.

For example, there is a voltage difference between the common voltage transmitted in the common electrode layer 7 and each of the first voltage signal, the second voltage signal and the clock signal.

Optionally, the number of target pins 8 can be two, and the two target pins 8 are of different types. The two target pins 8 are, for example, two of the first voltage signal pin 81, the second voltage signal pin 82 and the clock signal pin 83.

Optionally, the number of target pins 8 can be three, and the three target pins 8 are of different types. The three target pins 8 are, for example, the first voltage signal pin 81, the second voltage signal pin 82 and the clock signal pin 83.

Optionally, the number of target pins 8 can be more, and some of the target pins 8 are used to transmit display signals to the display panel 300.

For example, as shown in FIGS. 5A and 5B, the second control signal line 622 is electrically connected to a target pin 8. The target pin 8 can receive a control voltage signal (i.e., the control signal) and transmit the control voltage signal to the first control signal line 621 through the second control signal line 622.

Here, the target pin 8 electrically connected to the second control signal line 622 only needs to receive one control voltage signal. For example, the second control signal line 622 is electrically connected to only one of the first voltage signal pin 81, the second voltage signal pin 82 and the clock signal pin 83. Correspondingly, the control voltage signal is one of the first voltage signal, the second voltage signal, and the clock signal.

With the above arrangement, the control voltage signal transmitted in the target pin 8 may be transmitted to the second control signal line 622, and finally transmitted to the control electrode 52 through the first control signal line 621, so that the electric field is formed between the common electrode layer 7 and the control electrode 52 to bind the impurity ions. Moreover, in the case where the conductive layer 6 is made of the metal material (e.g., copper, gold, or silver), compared with the transparent conductive material (e.g., indium tin oxide), the resistance of the metal material is relatively small. By arranging the first control signal line 621 and the second control signal line 622 in the conductive layer 6, the resistances of the first control signal line 621 and the second control signal line 622 may be relatively small, which may reduce the attenuation of the control signal transmitted to the control electrode 52. Thus, it is beneficial to ensure the stability of the control signal, thereby ensuring the strength of the electric field between the control electrode 52 and the common electrode layer 7, and helping ensure the binding effect on impurity ions.

In some embodiments, as shown in FIGS. 10C and 10D, an access end 622A of the second control signal line 622 is spaced apart from the first bonding region B1 and does not extend into the first bonding region B1 to be directly connected to the first bonding region B1. Optionally, the conductive layer 6 further includes connection line(s) 63, a first end 63A of a connection line 63 is bonded to a target pin 8, and a second end 63B of the connection line 63 is electrically connected to the access end 622A of the second control signal line 622. That is, the access end 622A of the control signal line 62 is electrically connected to the target pin 8 through the connection line 63.

There may be a plurality of connection lines 63, and first ends 63A of the plurality of connection lines 63 are electrically connected to target pins 8 of different types. For example, three connection lines 63 are illustrated in FIGS. 10C and 10D, the first ends 63A of the three connection lines 63 are connected to different target pins 8, and the second end 63B of one of the three connection lines 63 is electrically connected to the second control signal line 622. That is to say, the other two connection lines 63 can be used as alternatives. After the connection line 63 electrically connected to the second control signal line 622 is damaged, the second control signal line 622 can be reconnected to the alternative connection line 63, thereby achieving input of the control signal to the second control signal line 622. Thus, it is convenient for the maintenance of the dimming panel 100.

There are multiple ways to electrically connect the access end 622A of the second control signal line 622 and the second end 63B of the connection line 63.

In some examples, as shown in FIG. 10C, the second end 63B of the connection line 63 and the access end 622A of the second control signal line 622 constitute a one-piece structure.

That is, in a process of manufacturing the conductive layer 6, the access end 622A of the second control signal line 622 and the connection line 63 electrically connected thereto are continuous and not disconnected. In this way, after the conductive layer 6 is manufactured, the electrical connection between the second control signal line 622 and the connection line 63 may be achieved, which may reduce the wiring difficulty of the conductive layer 6 and simplify the manufacturing process of the dimming panel 100.

In some other examples, as shown in FIGS. 10D and 10E, the second end 63B of the connection line 63 is spaced apart from the access end 622A of the second control signal line 622. That is, in a process of manufacturing the conductive layer 6, the access end 622A of the second control signal line 622 and the connection line 63 electrically connected thereto are disconnected. The functional electrode layer 5 further includes a bridge pattern 53 located on the second end of the connection line 63 and the access end 622A of the second control signal line 622, and the second end 63B of the connection line 63 is electrically connected to the access end 622A of the second control signal line 622 through the bridge pattern 53.

For example, one end of the bridge pattern 53 passes through a corresponding via hole in an insulating layer therebelow to be in contact with the second end 63B of the connection line 63, thereby achieving the electrical connection; and the other end of the bridge pattern 53 passes through a corresponding via hole in the insulating layer therebelow to be in contact with the access end 622A of the second control signal line 622, thereby achieving the electrical connection.

With the above arrangement, even if the access end 622A of the second control signal line 622 is far away from the second end 63B of the connection line 63, the electrical connection may also be achieved through the bridge pattern 53, which may improve the flexibility of the positions of the access end 622A of the second control signal line 622 and the second end 63B of the connection line 63, thereby helping improve the wiring flexibility of the conductive layer 6.

In some embodiments, as shown in FIGS. 5A and 5B, the access end 622A of the second control signal line 622 is arranged opposite to a region occupied by the target pin 8.

The “opposite” here may mean that in a direction perpendicular to an extension direction of the first bonding region B1, the access end 622A of the second control signal line 622 and the region occupied by the target pin 8 are directly opposite.

With the above arrangement, the distance between the access end 622A of the second control signal line 622 and the target pin 8 may be reduced, the difficulty of connecting the access end 622A of the second control signal line 622 to the target pin 8 may be reduced, and the winding complexity of the connection line 63 may be reduced, thereby reducing the design and manufacturing difficulty of the dimming panel 100.

In some embodiments, as shown in FIG. 5C, the control electrode 52 includes a first sub-line 521, a second sub-line 522, a third sub-line 523 and a fourth sub-line 524 that are connected end to end in sequence. The first sub-line 521 is located on a side of the display region AA proximate to the first bonding region B1, and the first sub-line 521 and the fourth sub-line 524 are disconnected from each other to form an opening; and the opening is arranged opposite to the first bonding region B1.

For example, the control electrode 52 is in a shape of a ring with an opening.

For example, in combination with FIG. 5B, the first sub-line 521 is located below the display region AA, the second sub-line 522 is located on the left side of the display region AA, the third sub-line 523 is located above the display region AA, and the fourth sub-line 524 is located on the right side of the display region AA.

By making the opening opposite to the first bonding region B1, the opening may provide space for arranging other electrodes (such as the driving electrode 51), which is beneficial for the flexible arrangement of the position of the driving electrode 51.

In some embodiments, as shown in FIGS. 5A and 5B, the first control signal line 621 is in a shape of a ring with an opening.

For example, as shown in FIGS. 5B and 5D, the first control signal line 621 includes a fifth sub-line 6211, a sixth sub-line 6212, a seventh sub-line 6213 and an eighth sub-line 6214 that are connected end to end in sequence; and in combination with FIG. 5B, the fifth sub-line 6211 is located below the display region AA, the sixth sub-line 6212 is located on the left side of the display region AA, the seventh sub-line 6213 is located above the display region AA, and the eighth sub-line 6214 is located on the right side of the display region AA. The fifth sub-line 6211 and the eighth sub-line 6214 are disconnected and spaced apart to provide an avoidance space for other structures.

In some examples, as shown in FIG. 5A, the second control signal line 622 has two access ends 622A, and the two access ends 622A are electrically connected to target pins 8.

For example, as shown in FIG. 5D, the second control signal line 622 includes a ninth sub-line 6221 and a tenth sub-line 6222 that are disconnected from each other. The two access ends 622A can be represented as a first access end 62A1 and a second access end 62A2. The first access end 62A1 is located in the ninth sub-line 6221, and the second access end 62A2 is located in the tenth sub-line 6222.

The first access end 62A1 and the second access end 62A2 are both arranged near the first bonding region B1, the first access end 62A1 is electrically connected to a target pin 8 in the first bonding region B1 through a connection line, and the second access end 62A2 is electrically connected to another target pin 8 in the first bonding region B1 through a connection line. Moreover, the target pin 8 electrically connected to the first access end 62A1 and the target pin 8 electrically connected to the second access end 62A2 are target pins 8 of the same type, so that the signals input by the target pins 8 to the second control signal line 622 are the same signal.

For example, the target pins 8 in the first bonding region B1 are bonded to a flexible circuit board, and the flexible circuit board can provide the control signal to the target pins 8; and the target pins 8 can transmit the control signal to the access ends 622A of the second control signal line 622.

With the above arrangement, the control signal may be input into the control signal line 62 from the two access ends 622A of the control signal line 62 at the same time, which reduces the attenuation of the control signal in the control signal line 62, and makes the control voltage in the control signal line 62 more stable, thereby ensuring the stability of the electric field formed between the common electrode layer 7 and the control electrode 52, and ensuring the binding effect on impurity ions.

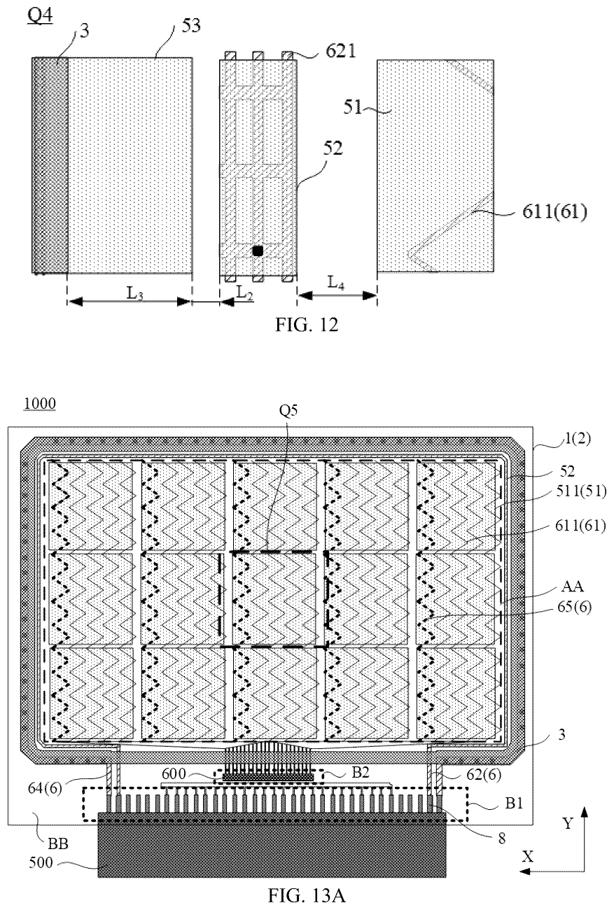

In some embodiments, as shown in FIGS. 11 and 12, at least a portion of the first control signal line 621 is in a shape of a grid, and/or at least a portion of the second control signal line 622 is in a shape of a grid.

In this way, it may be possible to enhance the flexibility of the first control signal line 621 and/or the second control signal line 622, which may enhance the bending resistance of the first control signal line 621 and/or the second control signal line 622, and avoid damage to the first control signal line 621 and/or the second control signal line 622 due to bending. Furthermore, the above arrangement may also reduce the shielding effect of the first control signal line 621 on light, thereby improving the dimming effect of the dimming panel 100.

In some embodiments, as shown in FIG. 6, a minimum distance Li between an orthographic projection of the control electrode 52 on the first substrate 1 and an orthographic projection of the frame sealant 3 on the first substrate 1 is greater than or equal to 0.2 mm.

For example, in the case where the control electrode 52 includes the first sub-line 521, the second sub-line 522, the third sub-line 523 and the fourth sub-line 524 that are connected end to end in sequence, distances between the frame sealant 3 and the first sub-line 521, the second sub-line 522, the third sub-line 523 and the fourth sub-line 524 can be the same, which may simplify the design difficulty of the dimming panel 100. Alternatively, the distances between the frame sealant 3 and the first sub-line 521, the second sub-line 522, the third sub-line 523 and the fourth sub-line 524 can be different, which may increase the flexibility of arranging the control electrode 52 in the dimming panel 100.

For example, as shown in FIGS. 5B and 5C, in the case where the distances between the frame sealant 3 and the first sub-line 521, the second sub-line 522, the third sub-line 523 and the fourth sub-line 524 are the same, and the minimum distance L₁ between the control electrode 52 and the frame sealant 3 is a distance between any position of the control electrode 52 and the frame sealant 3.

For example, in the case where the distances between the frame sealant 3 and the first sub-line 521, the second sub-line 522, the third sub-line 523 and the fourth sub-line 524 are different, the minimum distance L₁ can be a distance between the first sub-line 521 and the frame sealant 3, or a distance between the second sub-line 522 and the frame sealant 3, or a distance between the third sub-line 523 and the frame sealant 3, or a distance between the fourth sub-line 524 and the frame sealant 3. The smallest distance among the above distances is taken as the value of L₁.

For example, the distance L₁ is 0.2 mm, 0.21 mm, 0.22 mm, 0.23 mm, or 0.25 mm.

Correspondingly, in a case where the dimming panel 100 is relatively large in size, the distance L₁ can be set relatively large.

It can be understood that the frame sealant 3 is made of the organic material, and the frame sealant 3 has a certain fluidity before curing.

With the above setting, an error space may be reserved between the frame sealant 3 and the control electrode 52. During the process of manufacturing the frame sealant 3, the material of the frame sealant 3 may be prevented from flowing and covering the control electrode 52, thereby avoiding affecting the electric field formed between the control electrode 52 and the common electrode layer 7.

In some embodiments, as shown in FIGS. 5A and 5B, the functional electrode layer 5 further includes a transfer electrode 53 located in the peripheral region BB. The transfer electrode 53 is disposed on a surface of the frame sealant 3 proximate to the first substrate 1. That is, the transfer electrode 53 is in direct contact with the frame sealant 3. The conductive layer 6 further includes a common voltage signal line 64 located in the peripheral region BB.

For example, the common voltage signal line 64 is used to introduce the common voltage signal and transmit the common voltage signal to the common electrode layer 7.

It should be understood that there are multiple ways for the electrical connection between the common voltage signal line 64 and the common electrode layer 7, which can be determined specifically according to the position of the common electrode layer 7.

In another implementation, in a case where the common electrode layer 7 is located between the conductive layer 6 and the functional electrode layer 5, after the transfer electrode 53 is electrically connected to the common electrode layer 7 through a via hole, the common electrode layer 7 is electrically connected to the common voltage signal line 64 through a via hole. In this case, in a process of manufacturing the dimming panel 100, two punching processes are required to achieve the electrical connection between the transfer electrode 53 and both the common electrode layer 7 and the common voltage signal line 64.

In some embodiments of the present disclosure, as shown in FIG. 7, the transfer electrode 53 is electrically connected to the common electrode layer 7, and the transfer electrode 53 is further electrically connected to the common voltage signal line 64.

For example, a portion of the transfer electrode 53 passes through the insulating layer between the functional electrode layer 5 and the common electrode layer 7 to be in contact with the common electrode layer 7, and another portion of the transfer electrode 53 passes through the insulating layer between the functional electrode layer 5 and the common electrode layer 7, the common electrode layer 7, and the insulating layer between the common electrode layer 7 and the conductive layer 6 to be in contact with the common voltage signal line 64. The common voltage signal line 64 is connected to the common electrode layer 7 through the transfer electrode 53.

In this way, the common voltage signal transmitted in the common voltage signal line 64 may be transmitted to the transfer electrode 53, and then transmitted to the common electrode layer 7 through the transfer electrode 53. The above arrangement in the embodiments of the present disclosure may achieve the electrical connection between the transfer electrode 53 and both the common electrode layer 7 and the common voltage signal line 64 through a single punching process after the insulating layer between the functional electrode layer 5 and the common electrode layer 7 is manufactured. Compared with the above-mentioned another implementation, one punching process is reduced, so that the manufacturing process of the dimming panel 100 may be simplified. In some other examples, as shown in FIG. 6, in the case where the common electrode layer 7 is located on the side of the second substrate 2 proximate to the first liquid crystal layer 4, the common electrode layer 7 is in contact with the frame sealant 3, and the frame sealant 3 has conductive particles.

For example, the conductive particles of the frame sealant 3 include gold balls.

For example, the transfer electrode 53 passes through the insulating layer between the functional electrode layer 5 and the conductive layer 6 to be in contact with the common voltage signal line 64. Since the common electrode layer 7 is in contact with the frame sealant 3, the common voltage signal line 64 can be electrically connected to the common electrode layer 7 through the transfer electrode 53 and the frame sealant 3 in sequence.

In some embodiments, as shown in FIGS. 10A, 11, and 12, a distance L₂ between an orthographic projection of the transfer electrode 53 on the first substrate 1 and an orthographic projection of the control electrode 52 on the first substrate 1 is less than or equal to 0.05 mm.

For example, the distance L₂ is 0.05 mm, 0.04 mm, 0.03 mm, 0.02 mm, or 0.01 mm.

The strength of the electric field formed between the two electrodes is inversely proportional to the distance between the two electrodes. With the above setting, the distance between the transfer electrode 53 and the control electrode 52 may be made relatively small, so that a strong electric field may be formed between the transfer electrode 53 and the control electrode 52, which assists the electric field between the control electrode and the common electrode layer to enhance the binding effect on the impurity ions P, and further alleviates the light leakage in a partial region of the display region AA proximate to the peripheral region BB.

In some embodiments, as shown in FIGS. 5A, 5B, 6 and 7, in the region where the orthographic projection of the frame sealant 3 on the first substrate 1 overlaps with the orthographic projection of the transfer electrode 53 on the first substrate 1, the orthographic projection of the frame sealant 3 on the first substrate 1 is within the orthographic projection of the transfer electrode 53 on the first substrate 1.

As described above, in FIGS. 6 and 7, an insulating layer is disposed between two adjacent conductive film layers of the dimming panel 100. The insulating layer is generally made of an inorganic material such as silicon nitride or silicon oxide, and the bonding strength between the frame sealant 3 and the inorganic material is relatively weak. With the above arrangement, the frame sealant 3 may be directly in contact with the transfer electrode 53, thereby enhancing the bonding strength between the frame sealant 3 and the transfer electrode 53.

For example, as shown in FIG. 12, a minimum distance L₃ between an edge of the transfer electrode 53 and an edge of the frame sealant 3 is 0.25 mm.

The frame sealant 3 has a fluidity before curing. Through the above setting, an error space may be reserved between the edge of the transfer electrode 53 and the edge of the frame sealant 3 to prevent the frame sealant 3 from flowing the region between the transfer electrode 53 and the control electrode 52 during the process of manufacturing the frame sealant 3, thereby avoiding affecting the intensity of the electric field formed between the transfer electrode 53 and the control electrode 52.

In some examples, as shown in FIG. 12, a minimum distance L₄ between an orthographic projection of the driving electrode 51 on the first substrate 1 and an orthographic projection of the control electrode 52 on the first substrate 1 is greater than or equal to 0.13 mm.

For example, the minimum distance L₄ between the orthographic projection of the driving electrode 51 on the first substrate 1 and the orthographic projection of the control electrode 52 on the first substrate 1 is 0.13 mm, 0.14 mm, 0.15 mm, 0.16 mm or 0.17 mm.

With the above setting, it may be ensured that there is a sufficient distance between the driving electrode 51 and the control electrode 52, so as to avoid the control signal transmitted in the control electrode 52 from having an adverse effect on the driving signal transmitted in the driving electrode 51, thereby avoiding affecting the electric field formed between the driving electrode 51 and the common electrode layer 7, and ensuring the normal deflection of part of the liquid crystal molecules in the first liquid crystal layer 4 corresponding to the driving electrode 51.

It should be understood that, L₄ may be set as large as possible according to the size of the dimming panel 100, which may minimize the influence of the control signal transmitted in the control electrode 7 on the driving signal transmitted in the driving electrode 51.

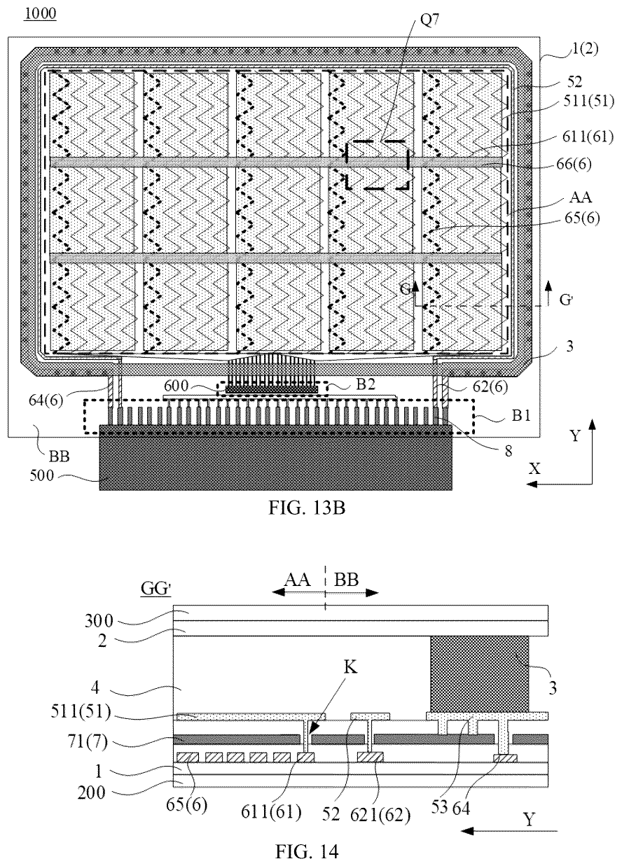

In some embodiments, as shown in FIGS. 13A and 13B, the driving signal line 61 is polyline-shaped.

It should be noted that, in order to clearly show the relative positional relationship of the components in the dimming panel 100, the backlight module 200 and the display panel 300 are not illustrated in FIGS. 13A and 13B.

Moiré pattern is a visual phenomenon in which interference fringes are formed after light passes through an object with regular intervals.

By arranging the driving signal lines 61 to be polyline-shaped, it may be possible to avoid forming the regular intervals between the driving signal lines 61 and avoid generating the moiré pattern after light passes through the driving signal lines 61. Thus, it is beneficial to ensure the display effect of the display device 1000.

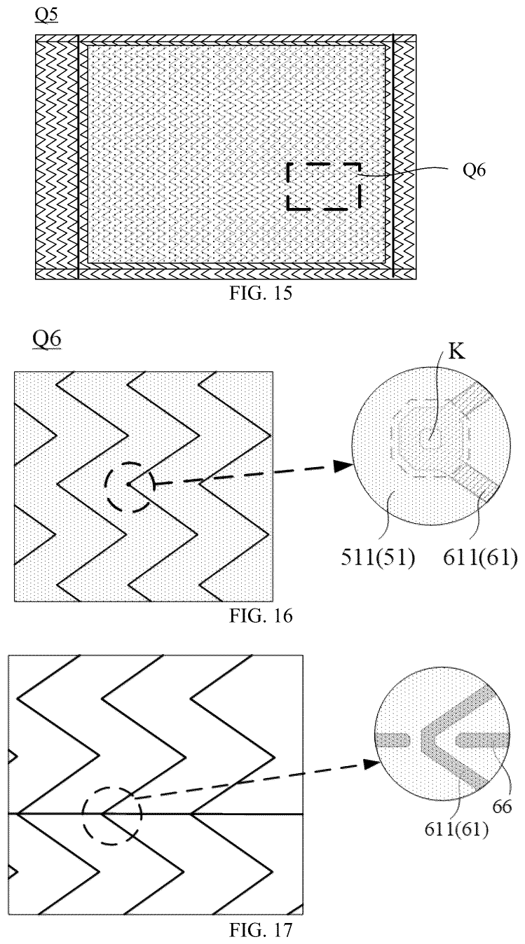

In some embodiments, as shown in FIGS. 13A, 13B and 14, in the case where the common electrode layer 7 is located between the conductive layer 6 and the functional electrode layer 5, the driving electrode 51 includes a plurality of driving electrode blocks 511, and the plurality of driving electrode blocks 511 are arranged in multiple rows and multiple columns. The driving signal line(s) 61 include a plurality of driving signal sub-lines 611. The plurality of driving signal sub-lines 611 extend in the column direction Y and are sequentially arranged at intervals in the row direction X. The common electrode layer 7 has a plurality of via holes K; and as shown in FIGS. 15 and 16, a driving electrode block 511 passes through a corresponding via hole K to be electrically connected to a driving signal sub-line 611.

For example, as shown in FIG. 14, an insulating layer is provided between the functional electrode layer 5 and the common electrode layer 7, and an insulating layer is provided between the common electrode layer 7 and the conductive layer 6; and a driving electrode block 511 can pass through the insulating layers and the common electrode layer 7 to be electrically connected to a driving signal sub-line 611.

For example, the plurality of driving signal sub-lines 611 transmit the same driving signal or different driving signals.

By arranging the plurality of driving electrode blocks 511 and arranging the driving signal sub-lines 611 electrically connected to the driving electrode blocks 511, it may be possible to achieve independent control of each driving electrode block 511, and thus achieve control of the deflection direction of the liquid crystal molecules in the region corresponding to each driving electrode block 511. Therefore, the light passing through each driving electrode block 511 may be controlled, thereby achieving the regional control of the light passing through the dimming panel 100.

In some embodiments, as shown in FIGS. 13A, 13B and 14, the conductive layer 6 further includes a plurality of transmission signal lines 65 located in the display region AA, and the plurality of transmission signal lines 65 extend in the column direction Y and are sequentially arranged at intervals in the row direction X. A single column of driving electrode blocks 511 corresponds to at least one transmission signal line 65.

For example, a single column of driving electrode blocks 511 corresponds to one transmission signal line 65, or a single column of driving electrode blocks 511 corresponds to multiple transmission signal lines 65.

For example, there may be a situation where one of all the driving signal sub-lines 611 works abnormally due to a manufacturing defect, which may make it difficult for the driving signal sub-line 611 to transmit the driving signal to the corresponding driving electrode block 511. In this case, the transmission signal line 65 as an alternative can be electrically connected to the corresponding driving electrode block 511, and the transmission signal line 65 can be used to transmit the driving signal to the corresponding driving electrode block 511, so that the corresponding driving electrode block 511 can normally receive the driving signal.

With the above arrangement, the reliability of the dimming panel 100 may be improved, the defect rate of the dimming panel 100 may be reduced, and thus the production cost of the dimming panel 100 may be reduced.

In some embodiments, different from FIG. 13A, in FIG. 13B, the conductive layer 6 further includes a plurality of light-shielding lines 66 located in the display region AA. The plurality of light-shielding lines 66 extend in the row direction X and are sequentially arranged at intervals in the column direction Y. An orthographic projection of the light-shielding line 66 on the first substrate 1 is located between orthographic projections of two adjacent rows of driving electrode blocks 511 on the first substrate 1.

It should be understood that there is a gap between two adjacent rows of driving electrode blocks 511. In a case where the electric field is formed between the driving electrode blocks 511 and the common electrode layer 7, it is difficult for the electric field to deflect the liquid crystal molecules located in the gap (that is, it is impossible to adjust the light passing through the gap), which may cause the light leakage of the display device 1000. The light-shielding line 66 can block the light. By arranging the light-shielding line 66 between two adjacent rows of driving electrode blocks 511, it may prevent the light from exiting from the gap between the two rows of driving electrode blocks 511, thereby avoiding the light leakage of the display device 1000.

In some embodiments, as shown in FIG. 13B, in the column direction Y, a dimension of an orthographic projection of the light-shielding line 66 on the first substrate 1 is greater than or equal to a dimension of the gap between orthographic projections of two adjacent rows of driving electrode blocks 511 on the first substrate 1.

With the above arrangement, the light-shielding line 66 may completely cover the gap between two adjacent rows of driving electrode blocks 511, thereby further improving the shielding effect of the light-shielding line 66 on the light exiting from the gap between the two rows of driving electrode blocks 511, and avoiding the light leakage of the display device 1000.

In some embodiments, as shown in FIGS. 13B and 17, the light-shielding line 66 is disconnected at an intersection between the light-shielding line 66 and the driving signal sub-line 611.

Through the above arrangement, the interference between the driving signal sub-line 611 and the light-shielding line 66 may be avoided, thereby preventing the light-shielding line 66 from affecting the transmission of the driving signal in the driving signal sub-line 611.

It should be noted that, the light-shielding line 66 is also disconnected at an intersection between the light-shielding line 66 and the transmission signal line 65, which may also avoid the interference between the transmission signal line 65 and the light-shielding line 66.

In some embodiments, as shown in FIGS. 13A and 13B, the display device 1000 provided in the embodiments of the present disclosure further includes a flexible circuit board 500 bonded to the target pin(s) 8 in the first bonding region B1 of the dimming panel 100.

For example, the flexible circuit board 500 is used to provide various electrical signals for the dimming panel 100.

For example, the flexible circuit board 500 is used to provide the first voltage signal transmitted in the first voltage signal pin 81; or the flexible circuit board 500 is used to provide the second voltage signal transmitted in the second voltage signal pin 82; or the flexible circuit board 500 is used to provide the clock signal transmitted in the clock signal pin 83.

For example, as shown in FIGS. 13A and 13B, the common voltage signal line 64 is electrically connected to the flexible circuit board 500, so as to transmit the common voltage signal from the flexible circuit board 500 to the common voltage signal line 64, and finally to the common electrode layer.

With the above arrangement, various electrical signals provided by the flexible circuit board 500 may be transmitted to the dimming panel 100, so that the dimming panel 100 may work normally.

In some embodiments, as shown in FIGS. 13A and 13B, in the dimming panel 100, the driving electrode 51 in the functional electrode layer 5 includes the plurality of driving electrode blocks 511, and the driving signal line(s) 61 include the plurality of driving signal sub-lines 611; and in this case, the peripheral region BB of the dimming panel 100 further includes a second bonding region B2, and the second bonding region B2 is located between the first bonding region B1 and the frame sealant 3 of the dimming panel 100. The plurality of driving signal sub-lines 611 extend out of the region defined by the frame sealant 3 and extend to the second bonding region B2.

As shown in FIGS. 13A and 13B, the display device 1000 further includes a driving chip 600 bonded to the second bonding region B2, and the driving chip 600 is electrically connected to the plurality of driving signal sub-lines 611.

For example, the driving chip 600 is used to provide driving signals to the plurality of driving signal sub-lines 611.

With the above arrangement, the driving signal sub-lines 611 may transmit the driving signals provided by the driving chip 600 to the driving electrode blocks 511 in the display region AA, so that each driving electrode block 511 may individually control the deflection direction of the liquid crystal in the region corresponding to the driving electrode block 511, thereby achieving the regional control of the light passing through the dimming panel 100.

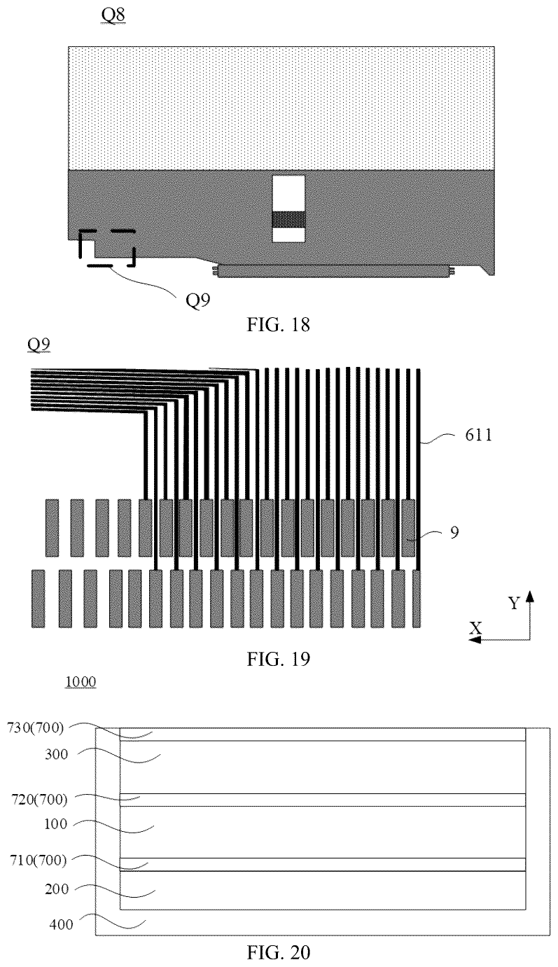

In some examples, as shown in FIGS. 10A, 18, and 19, the dimming panel 100 further includes a plurality of driving pins 9, and a single driving signal sub-line 611 is electrically connected to one driving pin 9.

For example, the driving pin 9 is further electrically connected to the driving chip 600.

In this way, the driving signal provided by the driving chip 600 may be transmitted to the driving signal sub-line 611 through the driving pin 9.

For example, as shown in FIG. 19, the driving pins 9 are arranged in two rows, and any two adjacent driving signal sub-lines 611 are electrically connected to driving pins 9 in different rows, respectively.

There are a large number of driving pins 9, so that the dimension of the region occupied by the plurality of driving pins 9 in the row direction X is large. By arranging the driving pins 9 into two rows, the dimension of the region occupied by the driving pins 9 in the row direction X may be reduced, which is beneficial to reducing the dimension of the dimming panel 100 in the row direction X.

In some embodiments, as shown in FIG. 20, the display device 1000 further includes polarizers 700, and the polarizers 700 include a first polarizer 710, a second polarizer 720 and a third polarizer 730. The first polarizer 710 is disposed between the backlight module 200 and the dimming panel 100. The second polarizer 720 is disposed between the dimming panel 100 and the display panel 300. A transmission axis of the second polarizer 720 is parallel to a transmission axis of the first polarizer 710. The third polarizer 730 is disposed on the display panel 300, and a transmission axis of the third polarizer 730 is perpendicular to the transmission axis of the first polarizer 710.

For example, the light emitted by the backlight module 200 is converted into first linearly polarized light after passing through the first polarizer 710. After the driving chip 600 outputs different driving signals to the driving electrode blocks 511, liquid crystal molecules in the first liquid crystal layer 4 corresponding to different driving electrode blocks have different deflection states, so that the polarization direction of the first linearly polarized light may be adjusted to different degrees. Since the transmission axis of the second polarizer 720 is parallel to the transmission axis of the first polarizer 710, after the first linearly polarized light passes through the dimming panel 100 and then through the second polarizer 720, the intensity of the light with a different polarization direction can change, which may achieve the control of the light intensities of different regions.

For example, the polarization direction of part of the first linearly polarized light does not change after passing through the dimming panel 100; and thus this part of light can all pass through the second polarizer 720, and the light intensity of this part of light does not change after passing through the second polarizer 720.

For another example, the polarization direction of part of the first linearly polarized light changes after passing through the dimming panel 100, and the angle of the polarization direction change is between 0° and 90°. Thus, this part of light can partially pass through the second polarizer 720, and the light intensity of the part of light can become weaker after passing through the second polarizer 720.

For another example, the polarization direction of part of the first linearly polarized light changes after passing through the dimming panel 100, and the angle of the polarization direction change is 90°. Thus, all of this part of light is blocked by the second polarizer 720, and the light intensity of this part of light is approximately 0 after passing through the second polarizer 720.

The light passing through the second polarizer 720 enters the display panel 300 and then exits from the third polarizer 730. Since the light in different regions has different intensities after passing through the second polarizer 720, the light passing through the second polarizer 720 may enhance the brightness difference between different display regions in the display device 1000 after passing through the display panel 300 and the third polarizer 730, thereby achieving high contrast display of the display device 1000.

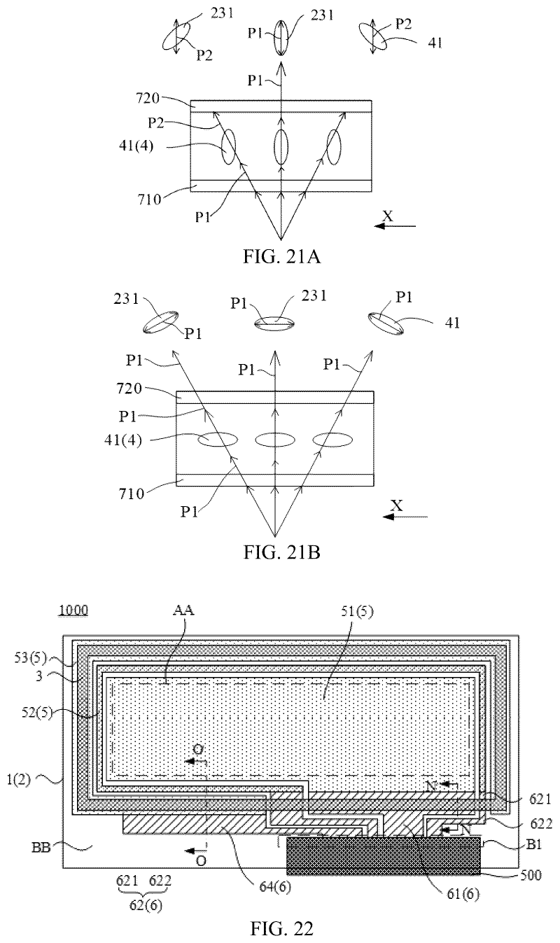

In some other embodiments, the dimming panel 100 of the display device 1000 is in a twisted nematic display mode. In this case, as shown in FIGS. 21A and 21B, the liquid crystal molecules in the first liquid crystal layer 4 of the dimming panel 100 are referred to as first liquid crystal molecules 41; in a case where an electric field is formed between the driving electrode 51 and the common electrode layer 7, as shown in FIG. 21A, the deflection state of the first liquid crystal molecules 41 is a vertical state; and in a case where no electric field is formed between the driving electrode 51 and the common electrode layer 7, as shown in FIG. 21B, the deflection state of the first liquid crystal molecules 41 is a horizontal state.

According to the optical properties of the first liquid crystal molecules 41, as shown in FIG. 21A, part of the light emitted by the backlight module 200 becomes the first linearly polarized light P1 after passing through the first polarizer 710. The first linearly polarized light P1 passes through the first liquid crystal molecules 41 of the first liquid crystal layer 4 with different incident directions. According to the polarization properties of the liquid crystal molecules, the light passing through the first liquid crystal molecules 41 along the optical axis direction of the first liquid crystal molecules 41 does not change its polarization direction, and is still the first linearly polarized light P1. Therefore, the light can pass through the second polarizer 720 having the same transmission axis direction as the first polarizer 710, and finally be directed to the display panel 300 to provide backlight for the display panel 300. After the light exits from the display panel 300, a visible region is formed on the light-exit side of the display device 1000. However, the light passing through the first liquid crystal molecules 41 along a direction different from the optical axis direction of the first liquid crystal molecules 41 changes its polarization direction (that is, the first linearly polarized light P1 with a side viewing angle changes its polarization direction after passing through the first liquid crystal molecules 41), and becomes second linearly polarized light P2, and the polarization direction of the second linearly polarized light P2 is different from the polarization direction of the first linearly polarized light P1. Therefore, it is difficult for the second linearly polarized light P2 to pass through the second polarizer 720 having the same transmission axis direction as the first polarizer 710, and it is impossible to provide backlight for the display panel 300. As a result, an invisible region on the light-exit side of the display device 1000 is formed (that is, people in the invisible region cannot clearly see the content displayed by the display device 1000), thereby achieving the privacy function of the display device 1000.

According to the optical properties of the first liquid crystal molecules 41, as shown in FIG. 21B, part of the light emitted by the backlight module 200 becomes the first linearly polarized light P1 after passing through the first polarizer 710. The first linearly polarized light P1 passes through the first liquid crystal molecules 41 of the first liquid crystal layer 4 with different incident directions. According to the polarization properties of the liquid crystal molecules, the polarization direction of the first linearly polarized light P1 after passing through the first liquid crystal molecules 41 of the first liquid crystal layer 4 is basically unchanged. Therefore, most of the first linearly polarized light P1 can pass through the second polarizer 720 having the same transmission axis direction as the first polarizer 710, and finally be directed to the display panel 300 to provide backlight for the display panel 300. In this way, the entire light-exit side of the display device 1000 is a visible region, thereby achieving the shared display of the display device 1000.

Through the above arrangement, the display device 1000 may have the shared display function and the privacy function.

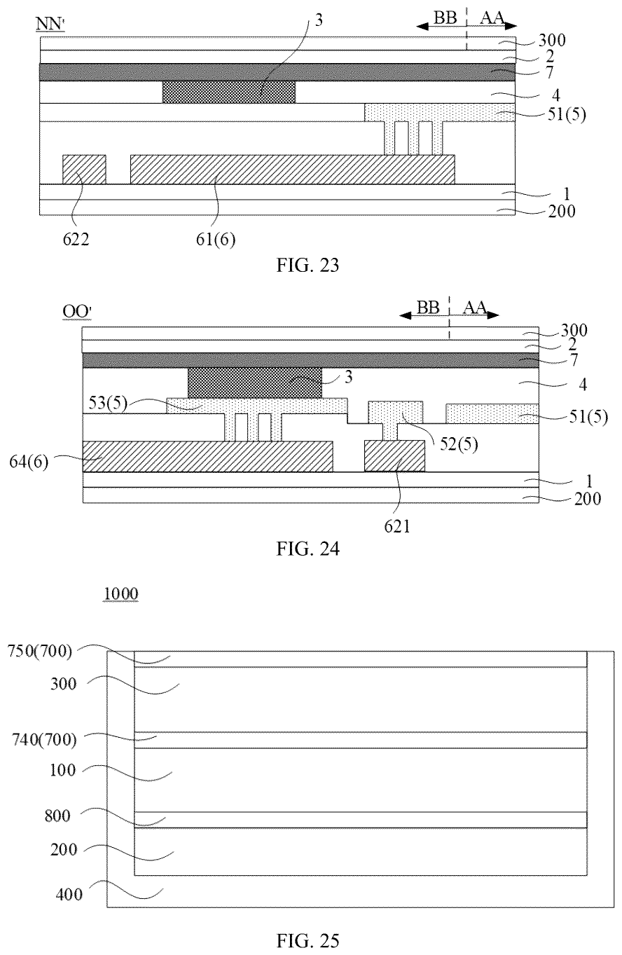

Furthermore, in the case where the display device 1000 has the shared display function and the privacy function, different from FIGS. 13A and 13B in which the driving chip 600 provides the driving signal(s) for the driving signal line(s) 61, in FIG. 22, the flexible circuit board 500 provides the driving signal(s) for the driving signal line(s) 61. In the case where the driving signal line(s) 61 include the plurality of driving signal sub-lines 611, the flexible circuit board 500 provides the same driving signal for different driving signal sub-lines 611, so that the electric field formed between the common electrode layer 7 and the driving electrode 51 in the dimming panel 100 is the same everywhere, the deflection directions of all the first liquid crystal molecules 41 in the first liquid crystal layer 4 are the same, and the polarization direction of the light passing through the first liquid crystal layer 4 is adjusted in the same way. Thus, the display device 1000 may achieve the shared display function and the privacy function in the entire display region. In this case, the connection between the driving signal line 61 and the driving electrode 51 in the dimming panel 100 can refer to FIG. 23, and the connection between the transfer electrode 53 and the common voltage signal line 64 in the dimming panel 100 can refer to FIG. 24.

In yet some other embodiments, the display mode of the first liquid crystal layer 4 in the dimming panel 100 of the display device 1000 is an advanced super dimension switch. As shown in FIG. 25, the display device 1000 further includes a privacy film 800 and polarizers 700, and the polarizers 700 includes a fourth polarizer 740 and a fifth polarizer 750. The privacy film 800 is disposed between the backlight module 200 and the dimming panel 100. The fourth polarizer 740 is disposed between the dimming panel 100 and the display panel 300. The fifth polarizer 750 is disposed on the display panel 300.

For example, directions of transmission axes of the fourth polarizer 740 and the fifth polarizer 750 are the same, or the directions of the transmission axes of the fourth polarizer 740 and the fifth polarizer 750 are perpendicular to each other.

For example, the privacy film 800 is used to narrow the emission range of the light emitted by the backlight module 200. That is, the light emitted by the backlight module 200 becomes collimated light after passing through the privacy film 800.

For example, in a case where no electric field is formed between the common electrode layer 7 and the driving electrode 51 in the dimming panel 100, the first liquid crystal molecules 41 in the first liquid crystal layer 4 are not deflected, and the emission range of the collimated light remains unchanged after passing through the dimming panel 100. Thus, a visible region may only be formed in a partial region of the light-exit side of the display device 1000, thereby achieving the privacy function of the display device 1000.

For example, in a case where an electric field is formed between the common electrode layer 7 and the driving electrode 51 in the dimming panel 100, the first liquid crystal molecules 41 in the first liquid crystal layer 4 are deflected, and the emission range of the collimated light becomes large after passing through the dimming panel 100. Thus, a visible region may be formed in an entire region of the light-exit side of the display device 1000, thereby achieving the shared display function of the display device 1000.

Through the above arrangement, the display device 1000 can have the privacy function and the shared display function.

The foregoing descriptions are merely specific implementation of the present disclosure, but the scope of protection of the present disclosure is not limited thereto, any changes or replacements that a person skilled in the art could conceive of within the technical scope of the present disclosure shall be included in the protection scope of the present disclosure. Therefore, the protection scope of the present disclosure should be determined by the protection scope of the claims.

1. A dimming panel having a display region and a peripheral region surrounding the display region, wherein the dimming panel comprises:
a first substrate and a second substrate that are arranged opposite to each other;
a frame sealant connecting the first substrate and the second substrate, wherein the frame sealant is located in the peripheral region and surrounds the display region;
a first liquid crystal layer disposed in a cavity enclosed by the first substrate, the frame sealant and the second substrate;
a functional electrode layer disposed on a side of the first substrate proximate to the first liquid crystal layer, wherein the functional electrode layer includes a control electrode located in the peripheral region and a driving electrode located in the display region, and the control electrode is located on a side of the frame sealant proximate to the display region, and surrounds at least a portion of the display region;
a conductive layer disposed between the first substrate and the functional electrode layer, wherein the conductive layer includes a control signal line and at least one driving signal line, and the control signal line includes a first control signal line and a second control signal line that are connected to each other; the first control signal line is located on the side of the frame sealant proximate to the display region, and the second control signal line is located on a side of the frame sealant away from the display region; the first control signal line is electrically connected to the control electrode; and a portion of a driving signal line is located in the display region, and the driving signal line is electrically connected to the driving electrode; and
a common electrode layer, wherein the common electrode layer is disposed between the conductive layer and the functional electrode layer or disposed on a side of the second substrate proximate to the first liquid crystal layer, wherein
there is a voltage difference between a control voltage transmitted to the control electrode from the first control signal line and a common voltage transmitted in the common electrode layer.

2. The dimming panel according to claim 1, wherein
an orthographic projection of the first control signal line on the first substrate is located between an orthographic projection of the frame sealant on the first substrate and an orthographic projection of the display region on the first substrate, and the orthographic projection of the first control signal line on the first substrate at least partially overlaps with an orthographic projection of the control electrode on the first substrate; and/or
a wiring shape of the first control signal line is same as that of the control electrode.

3. The dimming panel according to claim 1, wherein the peripheral region includes a first bonding region; and
the dimming panel further comprises at least one target pin located in the first bonding region, and the second control signal line is electrically connected to a target pin in the at least one target pin.

4. The dimming panel according to claim 3, wherein an access end of the second control signal line is spaced apart from the first bonding region;
the conductive layer further includes a connection line, a first end of the connection line is bonded to the target pin, and a second end of the connection line and the access end of the second control signal line constitute a one-piece structure; or
the conductive layer further includes a connection line, a first end of the connection line is bonded to the target pin, and a second end of the connection line is spaced apart from the access end of the second control signal line; and the functional electrode layer further includes a bridge pattern located on the second end of the connection line and the access end of the second control signal line, and the second end of the connection line is electrically connected to the access end of the second control signal line through the bridge pattern.

5. (canceled)

6. The dimming panel according to claim 3, wherein the control electrode includes a first sub-line, a second sub-line, a third sub-line and a fourth sub-line that are connected end to end in sequence; the first sub-line is located on a side of the display region proximate to the first bonding region, and the first sub-line and the fourth sub-line are disconnected from each other to form an opening; and the opening is arranged opposite to the first bonding region.

7. The dimming panel according to claim 6, wherein the first control signal line is in a shape of a ring with an opening; and
the second control signal line has two access ends, and each of the two access ends is electrically connected to a target pin.

8. The dimming panel according to claim 1, wherein at least a portion of the first control signal line is in a shape of a grid, and/or at least a portion of the second control signal line is in a shape of a grid, and/or
a minimum distance between an orthographic projection of the control electrode on the first substrate and an orthographic projection of the frame sealant on the first substrate is greater than or equal to 0.2 mm.

9. (canceled)

10. The dimming panel according to claim 1, wherein the functional electrode layer further includes a transfer electrode located in the peripheral region, and the transfer electrode is disposed on a surface of the frame sealant proximate to the first substrate;
the conductive layer further includes a common voltage signal line located in the peripheral region;
in a case where the common electrode layer is located between the conductive layer and the functional electrode layer, the transfer electrode is electrically connected to the common electrode layer, and the transfer electrode is further electrically connected to the common voltage signal line; and
in a case where the common electrode layer is located on a side of the second substrate proximate to the first liquid crystal layer, the common electrode layer is in contact with the frame sealant, and the frame sealant has conductive particles; and the transfer electrode is electrically connected to the common voltage signal line.

11. The dimming panel according to claim 10, wherein a distance between an orthographic projection of the transfer electrode on the first substrate and an orthographic projection of the control electrode on the first substrate is less than or equal to 0.05 mm.

12. The dimming panel according to claim 10, wherein an orthographic projection of the transfer electrode on the first substrate at least partially overlaps with an orthographic projection of the frame sealant on the first substrate.

13. The dimming panel according to claim 1, wherein a minimum distance between an orthographic projection of the driving electrode on the first substrate and an orthographic projection of the control electrode on the first substrate is greater than or equal to 0.13 mm; and/or
the driving signal line is polyline-shaped.

14. (canceled)

15. The dimming panel according to claim 1, wherein in a case where the common electrode layer is located between the conductive layer and the functional electrode layer, the driving electrode includes a plurality of driving electrode blocks, and the plurality of driving electrode blocks are arranged in multiple rows and multiple columns;
the at least one driving signal line includes a plurality of driving signal sub-lines, and the plurality of driving signal sub-lines extend in a column direction and are sequentially arranged at intervals in a row direction; and
the common electrode layer has a plurality of via holes, and a driving electrode block in the plurality of driving electrode blocks passes through a corresponding via hole in the plurality of via boles to be electrically connected to a driving signal sub-line in the plurality of driving signal sub-lines.

16. The dimming panel according to claim 15, wherein the conductive layer further includes a plurality of transmission signal lines located in the display region, and the plurality of transmission signal lines extend in the column direction and are sequentially arranged at intervals in the row direction; and
a column of driving electrode blocks corresponds to at least one transmission signal line in the plurality of transmission signal lines.

17. The dimming panel according to claim 15, wherein the conductive layer further includes a plurality of light-shielding lines located in the display region, and the plurality of light-shielding lines extend in the row direction and are sequentially arranged at intervals in the column direction; and
an orthographic projection of a light-shielding line in the plurality of light-shielding lines on the first substrate is located between orthographic projections of two adjacent rows of driving electrode blocks on the first substrate.

18. The dimming panel according to claim 17, wherein in the column direction, a dimension of the orthographic projection of the light-shielding line on the first substrate is greater than or equal to a dimension of a gap between the orthographic projections of two adjacent rows of driving electrode blocks on the first substrate; and/or
the light-shielding line is disconnected at an intersection between the light-shielding line and the driving signal sub line.

19. (canceled)

20. A display device, comprising:
a backlight module;
a dimming panel disposed on a light-exit side of the backlight module, wherein the dimming panel is the dimming panel according to claim 1; and
a display panel disposed on a side of the dimming panel away from the backlight module.

21. The display device according to claim 20, wherein the peripheral region includes a first bonding region; and the dimming panel further includes at least one target pin located in the first bonding region, and the second control signal line is electrically connected to a target pin in the at least one target pin; and
the display device further comprises a flexible circuit board bonded to the target pin in the first bonding region of the dimming panel.

22. The display device according to claim 21, wherein in the dimming panel, the driving electrode in the functional electrode layer includes a plurality of driving electrode blocks, and the at least one driving signal line includes a plurality of driving signal sub-lines;
the peripheral region of the dimming panel further includes a second bonding region, and the second bonding region is located between the first bonding region and the frame sealant of the dimming panel;
the plurality of driving signal sub-lines extend out of a region defined by the frame sealant and extend to the second bonding region; and
the display device further comprises a driving chip bonded to the second bonding region, and the driving chip is electrically connected to the plurality of driving signal sub-lines.

23. The display device according to claim 20, further comprising:
a first polarizer disposed between the backlight module and the dimming panel;
a second polarizer disposed between the dimming panel and the display panel, wherein a transmission axis of the second polarizer is parallel to a transmission axis of the first polarizer; and
a third polarizer disposed on the display panel, wherein a transmission axis of the third polarizer is perpendicular to the transmission axis of the first polarizer.

24. The display device according to claim 20, further comprising:
a privacy film disposed between the backlight module and the dimming panel;
a fourth polarizer disposed between the dimming panel and the display panel; and
a fifth polarizer disposed on the display panel.
